(19) United States
(12) Patent Application Publication
(10) Pub. No.: US 2023/0003211 A1
(43) Pub. Date: Jan. 5, 2023

(54) DEVICE FOR DELIVERING A FLUID TO A CONSUMPTION POINT AND ASSOCIATED METHOD

(71) Applicant: MEMOLUB INTERNATIONAL, Anderlecht (BE)

(72) Inventors: Pierre-Olivier MOUTHUY, Pont-à-Celles (BE); Christos MANIATIS, Ixelles (BE)

(21) Appl. No.: 17/853,264

(22) Filed: Jun. 29, 2022

(30) Foreign Application Priority Data
Jun. 30, 2021 (EP) 21182824.9

(51) Int. Cl. F04B 49/06; F04B 53/16; F04B 53/22; F04B 23/02; F04B 17/03

(52) U.S. Cl. CPC F04B 49/06; F04B 53/16; F04B 53/22; F04B 23/02; F04B 17/03; F04B 2203/0202; F04B 2207/701; F04B 2203/0201; F04B 2207/702; F04B 2201/0203

(57) ABSTRACT

A device for delivering a fluid to a consumption point is disclosed. The device comprises a pedestal comprising a mechanical coupling means for mechanically coupling the pedestal to the consumption point, a connector having an upper port and a lower port in fluidic communication, the lower port being configured to be fluidically coupled to the consumption point, and an electronic control unit for controlling the delivery of the fluid to the consumption point. The device further comprises a movable casing configured to be mounted on the pedestal and comprising a reservoir for storing an amount of the fluid, a pump system for pumping the fluid out of the reservoir to the upper port of the connector, a fluidic coupling means for fluidically coupling the reservoir to the upper port of the connector through the pump system, and an electrical coupling means for electrically coupling the movable casing to the pedestal.

### CROSS-REFERENCE TO RELATED APPLICATION

The present application claims the priority to European Patent Application No. 21182824.9, filed on Jun. 30, 2021, the entire contents of which is incorporated herein by reference.

### TECHNICAL FIELD

The present invention relates to a device for delivering a fluid to a consumption point. The present invention also relates to a method using such a device.

### BACKGROUND ART

U.S. Pat. No. 5,509,501 relates to a device for delivering a fluid to a consumption point. It comprises a cover portion comprising a reservoir for receiving the fluid, and a base portion comprising a pump for pumping the fluid from the reservoir to the consumption point. The base portion also comprises a motor which drives the pump and batteries which provide electricity to the motor. The device also comprises control means to control the operation frequency of the pump.

This device in the state of the art however is not entirely satisfactory.

Each consumption point has its own rate at which the fluid is to be provided. If one changes this rate, there is no possibility to know that such a change happened, and to keep a history of such changes. There is also no opportunity to detect possible anomalies without going to the device. And even like that, there is no indication of which types of anomalies exist.

Another problem of this device in the prior art is that the control means is not protected against undesired changes. It is exposed to anyone who wants to change the setting of the control means, including those not allowed. Consequently the reliability of the device is undermined if unexpected changes are made to the control means.

### DISCLOSURE OF THE INVENTION

It is an aim of the present invention to provide a device for which maintenance work is easier.

This aim is achieved according to the invention with a device for delivering a fluid to a consumption point, the device comprising:

a pedestal comprising:
mechanical coupling means for mechanically coupling the pedestal to the consumption point,
a connector having an upper port and a lower port in fluidic communication, the lower port being configured to be fluidically coupled to the consumption point, and
an electronic control unit for controlling the delivery of the fluid to the consumption point,

a movable casing configured to be mounted on the pedestal and comprising:
a reservoir for storing an amount of the fluid,
a pump system for pumping the fluid out of the reservoir to the upper port of the connector,
fluidic coupling means for fluidically coupling the reservoir to the upper port of the connector through the pump system when the movable casing is mounted on the pedestal,
electrical coupling means for electrically coupling the movable casing to the pedestal when the movable casing is mounted on the pedestal,

With the device of the invention, the electronic control unit in the pedestal plays a central role in its operation. The electronic control unit determines whether the pumping system pumps the fluid from the reservoir to the connector so as to provide the fluid to the consumption point. In addition, the electronic control unit can keep a record of the changes made to the setting of the device, giving a user a historical overview of the device. For example, with the record a user can know whether the rate of the fluid to the consumption point has been increased or decreased. Thanks to the electronic control unit, it is also possible to monitor different parameters linked to the operation of the delivery device, and detect possible faults. The electronic control unit is incorporated in the pedestal that remains at a given consumption point. Therefore, even when the movable casing is removed, for instance for refilling the reservoir, the settings linked to the pumping functions can remain unchanged.

The electronic control unit that is incorporated in the pedestal can be rendered inaccessible, even when the movable casing is removed. This prevents the settings from being modified against undesired changes.

The device of the present invention may comprise one or several of the following features under all technically possible combinations:

the electronic control unit comprises a switch for controlling the operation of the pump system, the switch being preferably a dual in-line package switch or a rotary encoder.

the pedestal has an upper surface around the upper port and a lower surface around the lower port, the switch being located on the upper surface of the pedestal such that when the pedestal is connected to the movable casing, the switch is unreachable to a user.

Consequently, once the movable casing is mounted on the pedestal it is impossible to alter the switch which would change the setting of the pump system.

the electronic control unit comprises a wireless communication module able to receive wireless instruction for the operation of the pump system or to send information on the operation of the pump system.

The wireless communication module allows a user to change the setting of the pump system without actually using the switch, or to monitor the measured parameters at a distance from the device.

the movable casing comprises a power source for supplying power to the pump system.

the electronic control unit comprises at least a sensor configured to sample a parameter of the movable casing.

The sensor measures the operation parameters of the device more precisely than an operator may do. It may also allow measurements to be carried out at a higher frequency. Furthermore, the data from the sensor(s) may be coupled with other components of the device to automate the operation of the device.

at least one sensor is able to send measured parameters via the wireless communication module.

A user can therefore monitor the measured parameters at a distance from the device.

the sensor is a voltage sensor of the power source, or an electric current sensor of the pump system, or an accelerometer, or a proximity sensor able to detect the presence of an operator, or a touch sensor able to detect the presence of an operator, or a magnetic sensor able to detect the presence of an operator.

the pedestal comprises at least an alarm able to emit a sound or a flashing light when the sensor measures a value of the parameter outside a pre-determined range.

This notifies a user of potential operational anomalies of the device by sound signals.

the pedestal is made of a transparent material, the pedestal comprising at least one light able to indicate an operation condition of the movable casing, or able to confirm an interaction with the operator.

The light gives a visual indication of an operation condition of the movable casing, or able to confirm the interaction of the device with a user.

the movable casing comprises at least an internal port configured to receive electric power and pass power on to the pump system.

the pedestal comprises a connector port configured to receive electric power from outside the device, and/or receive data from outside the device, and/or send data of the device away from the device.

the upper port of the connector is threaded, the movable casing comprising a threaded hole configured to cooperate with the threaded upper port of the connector such that the pedestal can be fluidically coupled to the movable casing by screwing the threaded hole of the movable casing onto the threaded upper port of the connector.

The threads preferably ensure an airtight connection between the pedestal and the movable casing.

The present invention also concerns a method of using a device as described above, comprising the following steps:

fluidically coupling the lower port of the connector to the consumption point, and mechanically coupling the pedestal to the consumption point,

fluidically coupling the reservoir to the upper port of the connector through the pump system by the fluidic coupling means,

positioning and mounting the movable casing on the pedestal,

the pump system pumping the fluid out of the reservoir to the upper port of the connector,

the fluid flowing in the connector from the upper port to the consumption point, the electronic control unit controlling the delivery of the fluid to the consumption point.

According to various embodiments of the invention, the method may comprise the following steps:

detaching the movable casing from the upper port of the connector while the pedestal remains attached to the consumption point,

coupling another movable casing to the upper port of the connector.

Since the setting of the device is kept in the electronic control unit, keeping the pedestal attached to the consumption point while the movable casings are changed means that the setting of a new movable casing is still adapted to the consumption point in question. Avoided are the situations where each movable casing needs to be individually set up before it is mounted onto the pedestal.

The method may comprise a step of setting up the switch before coupling the movable casing to the upper port of the connector.

### BRIEF DESCRIPTION OF THE DRAWINGS

The invention will be further explained by means of the following description and the appended figures.

FIG. 1 shows a perspective view from above of one embodiment of the device, with the shell of the movable casing partially removed;

FIG. 2 shows a perspective view from below of the device in the FIG. 1; and

FIG. 3 is an exploded view of the pedestal according to one embodiment of the invention.

### MODES FOR CARRYING OUT THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes. The dimensions and the relative dimensions do not necessarily correspond to actual reductions to practice of the invention.

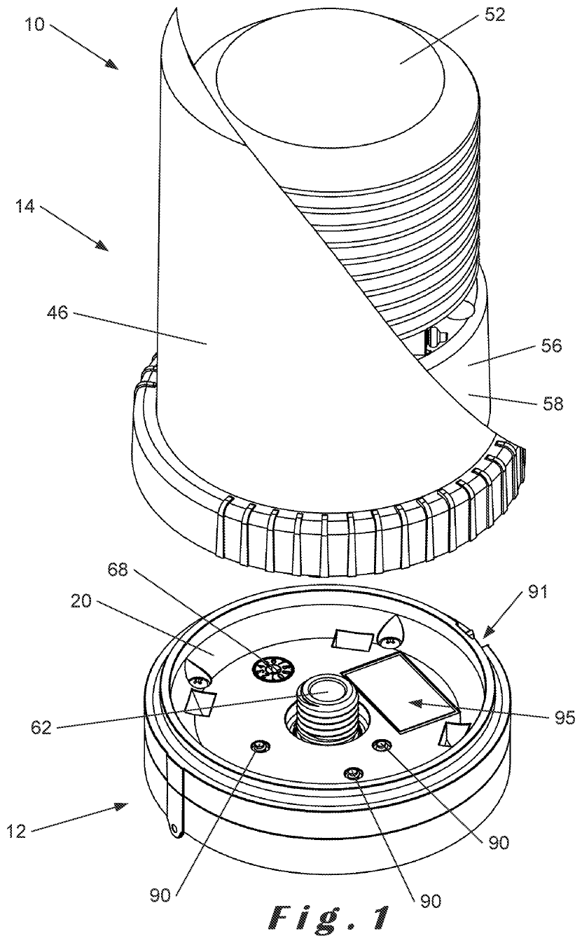

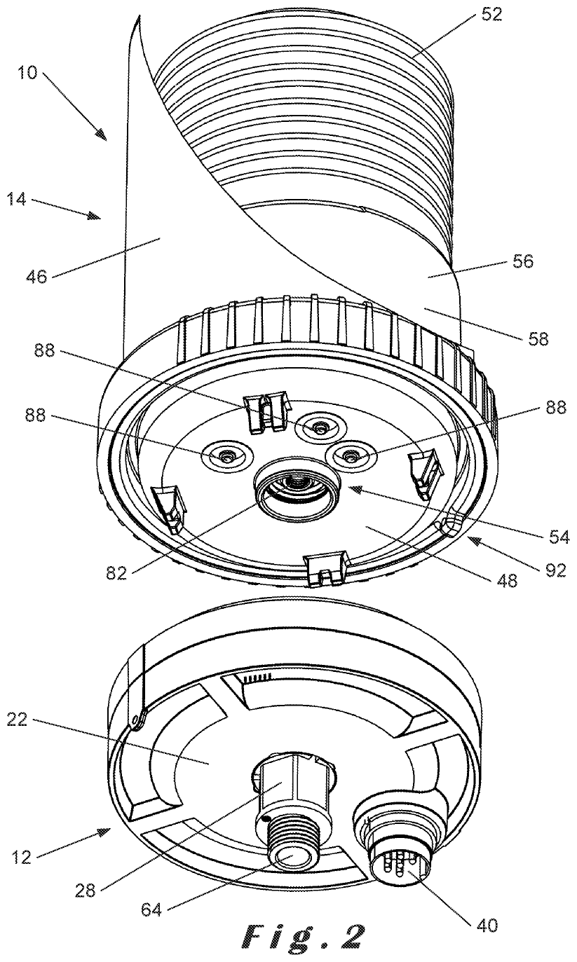

The FIGS. 1 and 2 show an embodiment of a device 10 according to the present invention.

The device 10 is configured to deliver a fluid to a consumption point (not shown in the Figures).

The device 10 comprises a pedestal 12 and a movable casing 14. The movable casing 14 is configured to be mounted on the pedestal 12.

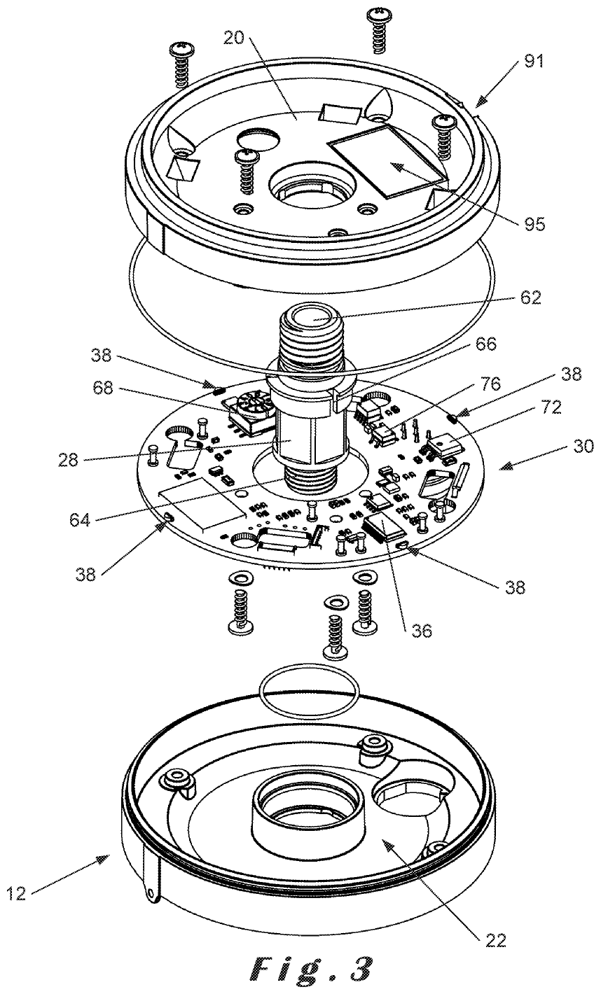

The pedestal 12 has an upper surface 20 and a lower surface 22. The pedestal 12 comprises a mechanical coupling means (not shown in the Figures). The pedestal 12 comprises a connector 28. The pedestal 12 comprises an electronic control unit 30, which is visible in the FIG. 3.

Preferably, the pedestal 12 also comprises an alarm 36. The pedestal 12 also preferably comprises at least a light 38. Optionally, the pedestal 12 comprises a connector port 40.

The movable casing 14 has a shell 46 and a bottom 48 closing the shell 46 to form a closed body. The movable casing 14 comprises a reservoir 52 for storing an amount of the fluid. The movable casing 14 comprises a fluidic coupling means 54 for fluidically coupling the reservoir 52 to the connector 28 through the pump system 56 when the movable casing 14 is mounted on the pedestal 12. The movable casing 14 comprises a pump system 56 for pumping the fluid out of the reservoir 52 to the connector 28. The pump system 56 comprises a pump piston (not represented on the Figures).

The movable casing 14 also comprises electrical coupling means for electrically coupling the movable casing 14 to the pedestal 12 when the movable casing 14 is mounted on the pedestal 12. The electrical coupling may be achieved by the contact between an internal port and a pin, as will be explained below. As an alternative, the electrical coupling may be achieved by inductive coupling.

According to one embodiment of the invention, the movable casing 14 also comprises a power source 58 for supplying power to the pump system 56.

According to the embodiments shown in the Figures, the pedestal 12 has a cylindrical shape. The upper surface 20 and the lower surface 22 of the pedestal 12 run approximatively parallel to each other.

The mechanical coupling means is configured to couple mechanically the pedestal 12 to the consumption point. According to one embodiment, the mechanical coupling means has two ends. Its first end is able to be screwed onto the pedestal 12, and its second end is able to be screwed onto the consumption point. According to a preferred embodiment, the mechanical coupling means is the connector 28.

The connector 28 has an upper port 62 and a lower port 64 in fluidic communication. According to the embodiment shown in the FIG. 3, the connector 28 goes across the pedestal 12.

Preferably the connector 28 also comprises a fluid channel 66 on its outer surface. When a fluid leak occurs in the movable casing 14, the fluid channel 66 ensures that leaked fluid is channeled outside the pedestal 12 without contacting the electronic control unit 30, thus better protecting the latter.

The connector 28 is for example made in brass. The connector 28 is for example in one single piece.

Preferably, when the movable casing 14 is not mounted on the pedestal 12, the pedestal 12 is able to rotate freely around the connector 28, and preferably also to slide up and down within a short range along the connector 28. These features allow the internal port 88 and the pin 90 to keep aligned when the movable casing 14 is fixed to the pedestal 12 during the mounting operation, provided that keyed connection between the protrusion 92 and the notch 91 (see below for additional explanation on the keyed connection) is secured.

As shown in the FIGS. 1 and 2, the upper surface 20 of the pedestal 12 surrounds the upper port 62. The lower surface 22 of the pedestal 20 surrounds the lower port 64.

The upper port 62 is configured to be connected to the reservoir 52, as will be described in more detail below. In a preferred embodiment, the upper port 62 is threaded.

The lower port 64 is configured to be fluidically coupled to the consumption point. According to one embodiment, the lower port 64 is connected to the mechanical coupling means.

The electronic control unit 30 is configured to control the delivery of the fluid to the consumption point. As illustrated in the FIG. 3, the electronic control unit 30 is sandwiched between the upper surface 20 and the lower surface 22 of the pedestal 12. The electronic control unit 30 has for example the form of a disk surrounding the connector 28, as shown in the FIG. 3.

As can be seen in the FIG. 3, the electronic control unit 30 is for example an electronic card.

The electronic control unit 30 is included in the pedestal 12 and remains fixed to the consumption point, in particular even when the movable casing 14 is removed, for instance for maintenance purposes. Examples of maintenance are: refilling the reservoir, change or maintenance of some components such as the pump. Consequently, the numerical identity of the device 10 is by essence linked to the consumption point.

Preferably, the electronic control unit 30 comprises a switch 68 (visible in the FIGS. 1 and 3). The switch 68 is configured to control the operation of the pump system 56. For example, the switch 68 is configured to control the rate at which the fluid is provided to the consumption point.

Preferably, the switch 68 is a rotary encoder, as seen in the Figures. As such a user can easily change the debit of the fluid provided to the consumption point by rotating the dial of the rotary encoder. According to one embodiment, the rotary encoder has at least two control positions. In one of the control positions the device 10 can only be set up wirelessly. Alternatively, the switch 68 may be a dual in-line package switch.

The switch 68 is preferably located on the upper surface 20 of the pedestal 12 such that when the pedestal 12 is connected to the movable casing 14, the switch 68 is unreachable to a user. Consequently, once the movable casing 14 is mounted on the pedestal 12 it is impossible to alter the switch 68 which would change the setting of the pump system 56.

In a preferred embodiment, the electronic control unit 30 comprises a wireless communication module 72 able to receive wireless instruction for the operation of the pump system 56. The wireless communication module 72 allows a user to change the setting of the pump system 56 without actually using the switch 68. According to one embodiment, the pumping frequency of the pump system 56 is determined solely by the instruction received remotely from outside the device 10.

As an alternative or an addition, the wireless communication module 72 is able to send information on the operation of the pump system 56 away from the device 10. This allows a user to monitor the operation of the pump system 56 remotely from the device 10. Different modes of remote monitoring can be envisaged by a person skilled in the art.

In the preferred embodiment, the electronic control unit 30 comprises at least a sensor 76 configured to sample a parameter of the movable casing 14. The parameter may include the voltage of the power source 58, the electric current through the pump system 56, and the acceleration of the pump piston. As such the sensors 76 may be a voltage sensor of the power source 58, and/or an electric current sensor of the pump system 56, and/or an acceleration sensor of the pump piston, an/or a temperature sensor of the device 10. When the reservoir 52 is low on the fluid, the acceleration of the pump piston is higher. According to one embodiment, the acceleration sensor is an accelerometer for the pump piston. The accelerometer is placed on the electronic control unit 30. According to another embodiment, the acceleration sensor is a microphone (not represented on the Figures). The microphone is located in the pedestal 12.

According to one embodiment of the invention, the sensor(s) 76 may include a proximity sensor able to detect the presence of an authorized operator near the device 10, within a preset distance from the device 10.

The sensors 76 can also include a touch sensor, activated when the operator touches the lower surface 22 of the pedestal 12 for a preset duration. The sensors 76 can also include a magnetic sensor, activated when a magnet is placed close to the pedestal 12 for a preset duration. The magnetic sensor (on a telescopic stick) can be used when the device 10 is not easily reachable by hand.

According to one embodiment of the invention, the electronic control unit 30 is able to determine the operation condition of the device 10 from the parameter(s) measured by the sensor(s) 76. For example, if all the parameters measured by the sensors 76 remain within their pre-determined ranges, the electronic control unit 30 determines that the device 10 is operating normally.

Preferably, at least one sensor 76 is able to send measured parameters via the wireless communication module 72 or the connector port 40. A user can therefore monitor the measured parameters remotely from the device 10. Different modes of remote monitoring are known by the skilled person. The range of the signal will depend not only on the emitter but also on the receptor, as well as the environment. For LoRa (abbreviation of Long Range) technology currently overseen by LoRa Alliance, ranges of several kilometres are possible. The final interface is aimed to be accessible anywhere through a smartphone, tablet, or computer terminal, using for example a server between the receptor and the interface. Then there is no limitation of distance anymore provided that the right environment is provided to the emitter.

The alarm 36 is able to emit a flashing light when the sensor 76 measures a value of the parameter outside a pre-determined range. In addition or as an alternative, the alarm 36 is configured to emit a sound when a sensor 76 measures a value of a parameter outside a pre-determined range. This notifies a user of potential operational anomalies of the device 10 by sound signals. For example, when the voltage sensor of the power source 58 detects that the value is too low, the alarm 36 emits a first type of sound, such as a continuous beep with a higher frequency f₁. As another example, when the electric current sensor of the pump system 56 detects that the value is too low, the alarm 36 emits a second type of sound, such as emitting beeps at regular intervals. Still as another example, when the acceleration sensor of the pump piston detects accelerations whose amplitude surpasses a threshold, the alarm 36 emits a third type of sound, such as a continuous beep at a lower frequency f₂.

According to one embodiment, the electronic control unit 30 is able save the operation history of the alarm 36.

The light 38 is able to indicate an operation condition of the movable casing 14, or able to confirm the interaction of the device 10 with a user. In the embodiment where the pedestal 12 comprises at least a light 38, the pedestal 12 is made of a transparent material, such as a transparent plastic material.

The light 38 is for example an RGB LED.

According to a preferred embodiment, the pedestal 12 comprises four lights 38. These four lights 38 are for example placed at the interval of 90° along the circumference of the pedestal 12. According to one embodiment, these four lights 38 are identical RGB LED. They achieve redundancy along the circumference of the pedestal 12 such that their light can be seen all around the pedestal 12. Various lights may display the same colour.

The lights 38 may have operational modes at different colours. A first red colour, is configured to light up when the current sensor detects that the current going through the pump system 56, for example going through the motor of the pump system 56, is below a threshold. A second yellow colour, is configured to light up when the voltage sensor detects that the voltage of the power source 58 falls below a threshold. A third blue colour, is configured to light up when the accelerometer detects that acceleration of the pump piston exceeds a threshold. Alternatively or in addition, the third colour is configured to light up when the temperature of the pump system 56 exceeds a threshold. A fourth green colour is configured to flash at regular intervals, for example every five minutes, if the device 10 is operating normally.

Preferably, the pedestal 12 also comprises a light of coupling able to indicate the state of coupling between the pedestal 12 and the movable casing 14. Preferably, only when the movable casing 14 is securely fixed to the pedestal 12 does the light of coupling light up. An example of this case is that only when the movable casing 14 is completely screwed onto the pedestal 12 does the light of coupling light up.

According to one embodiment, the pedestal 12 may comprise a touchscreen (not shown in the Figures). A user can give instructions to the device 10 via the touchscreen, and/or obtain information on the operation of the device 10 via the touchscreen. In this embodiment, as an alternative to the operation of the fourth colour explained above, the light 38 is configured to show the fourth colour when the touchscreen of the device 10 is functioning normally.

According to the embodiments represented in the Figures, the connector port 40 is located on the lower surface 22 of the movable casing 14. The connector port 40 is configured to receive electric power from outside the device 10. Electric power received by the connector port 40 for example has a voltage comprised between 12V and 48V, preferably at about 24V. According to this embodiment, the power source 58 in the movable casing 14 is optional.

Alternatively or in addition, the connector port 40 is able to receive data from outside the device 10, for example from a control module outside the device 10. Alternatively or in addition, the connector port 40 is able to send data of the device 10 outside the device 10. As such the connector port 40 acts as a communication interface between the device 10 and the outside of the device 10. According to this embodiment, the wireless communication module 72 is optional.

Preferably, the pedestal 12 also comprises a recess 95 for the user manual or a sticker.

According to a preferred embodiment of the present invention, the movable casing 14 is as described in U.S. Pat. No. 5,509,501, whose whole text is incorporated into this specification.

According to a preferred embodiment of the invention, the movable casing 14 lacks any electronic module able to modify the operation condition of the pump system 56, for example able to modify the pumping frequency of the pump system 56. The settings of the pump system 56 is controlled solely by the electronic control unit 30 in the pedestal 12.

The reservoir 52 for example has a volume comprised between 120 cm³ and 700 cm³.

In a preferred embodiment of the invention, the upper port 62 of the connector 28 is threaded as mentioned above. In this preferred embodiment the bottom 48 of the movable casing 14 comprises a threaded hole 82 configured to cooperate with the threaded upper port 62 of the connector 28 such that the pedestal 12 can be fluidically coupled to the movable casing 14 by screwing the threaded hole 82 of the movable casing 14 onto the threaded upper port 62 of the connector 28. The threads ensure an airtight connection between the pedestal 12 and the movable casing 14.

According to the embodiments shown in the Figures, the pump system 56 is configured to pump the fluid out of the reservoir 52 to the upper port 62 of the connector 28. Such a pump system 56 is well-known by a person skilled in the art.

The power source 58 of the movable casing 14 for example comprises at least a battery able to supply power to the pump system 56. According to this embodiment, preferably the power source 58 comprises at least a battery case (not shown in the Figures) intended to hold the battery.

Preferably, the power source 58 is also configured to provide power to the electronic control unit 30.

The movable casing 14 may also receive electric power from outside the device 10, for instance via the connector port 40. According to one embodiment, the movable casing 14 already comprises the power source 58, and the movable casing 14 receives electric power from outside the device 10, for instance via the connector port 40, in addition to the power source 58 inside the movable casing 14. This embodiment provides redundant power sources, such that the device 10 is able to operate normally even if either the power source outside the device 10 or the power source 58 inside the movable casing 14 fails. According to another embodiment, the movable casing 14 does not have any power source inside it. Power used by the device 10 comes solely from outside the device 10, for instance via the connector port 40.

The movable casing 14 comprises at least an internal port 88 (visible on the FIG. 2) configured to receive electric power from the pedestal 12 and/or to pass electric power to the pedestal 12. In the embodiment represented in the Figures, the movable casing 14 comprises three internal ports 88. These three internal ports 88 correspond for example respectively to the ground pin socket, the output pin socket, and the input pin socket.

When the movable casing 14 comprises at least an internal port 88, the pedestal 12 comprises preferably at least one pin 90 (visible on the FIG. 1) each corresponding to one internal port 88 respectively. The cooperation between each pair of the internal port 88 and the pin 90 ensures a good electric connection between the pedestal 12 and the movable casing 14, in particular for passing electric power between the pedestal 12 and the movable casing 14, and/or passing information from the electronic control unit 30 between the pedestal 12 and the movable casing 14. In addition, the insertion of each pin 90 into its corresponding internal port 88 requires precise angular positioning of the movable casing 14 with regard to the pedestal 12. This ensures for instance that only when the movable casing 14 is tightly screwed onto the pedestal 12 will the electric connection between the movable casing 14 and the pedestal 12 be established. The precise angular positioning of the movable casing 14 with respect to the pedestal 12 is obtained through a keyed connection, where a protrusion 92 on the bottom 48 of the movable casing 14 engages in a notch 91 on the upper surface 20 of the pedestal 12.

Preferably the device 10 comprises a seal (not shown in the Figures) between the pedestal 12 and the movable casing 14 such that once the movable casing 14 is mounted on the pedestal 12, any detachment between them necessarily breaks the seal.

The present invention also relates to a system comprising at least two devices 10 as disclosed above, and a central computer connected to each of the devices 10. This system allows a user to monitor and/or change the setting of each device 10 from one single location without having to visit each device 10. According to one embodiment of the invention, at least one device 10 sends information on its operation condition to the central computer at regular intervals, for example every four hours. Information on its operation condition may include the battery level, the type of fluid in the reservoir 52, the degree of vibration of the pump system 56 and/or of the reservoir 52, the temperature, and the total number of pumping cycles the current reservoir 52 has already completed.

In this system, the central computer and at least one of the devices 10 is connected via the wireless communication module 72. The wireless communication uses for example LoRa (abbreviation of Long Range) technology currently overseen by LoRa Alliance.

The method of using a device 10 as disclosed above will now be described.

First, the lower port 64 of the connector 28 is fluidically coupled to the consumption point. The pedestal 12 is mechanically coupled to the consumption point, for example since the connector 28 is part of the pedestal.

According to one embodiment, a user then sets up the pedestal 12, in particular by setting up the switch 68. The switch 68 typically controls the operation of the pump system 56. The user for example rotates the rotary encoder to set up the pumping frequency of the pump system 56.

Prior to mounting the movable casing 14 on the pedestal 12, according to one embodiment of the invention the shell 46 of the movable casing 14 is removed. If not present, batteries are inserted in the battery case and a reservoir 52 is fluidically coupled to the pump system 56 (not represented here). Then the shell 46 is placed on the bottom 48 of the movable casing 14. Then the movable casing 14 is positioned and mounted on the pedestal 12. This may be achieved by screwing the threaded hole 82 onto the threaded upper port 62 of the connector 28.

After the setup, the pump system 56 now pumps the fluid out of the reservoir 52 to the upper port 62 of the connector 28. The fluid then flows in the connector 28 from the upper port 62 to the lower port 64, then to the consumption point.

In this process the electronic control unit 30 controls the delivery of the fluid to the consumption point. This is for example done through the setting of the switch 68.

According to a preferred embodiment of the invention, when changing a movable casing 14 already mounted on the pedestal 12, first the movable casing 14 is detached from the upper port 62 of the connector 28 while the pedestal 12 remains attached to the consumption point. Next another movable casing 14 is coupled to the upper port 62 of the connector 28. Since the setting of the device 10 is kept in the electronic control unit 30, keeping the pedestal 12 attached to the consumption point while the movable casings 14 are changed means that the setting of a new movable casing 14 is still adapted to the consumption point in question. Avoided are the situations where each movable casing 14 needs to be individually set up before it is mounted onto the pedestal 12.

The terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

What is claimed:

1. A device for delivering a fluid to a consumption point, the device comprising:
a pedestal comprising:
a mechanical coupling means for mechanically coupling the pedestal to the consumption point,
a connector having an upper port and a lower port in fluidic communication, the lower port being configured to be fluidically coupled to the consumption point, and
an electronic control unit for controlling the delivery of the fluid to the consumption point; and
a movable casing configured to be mounted on the pedestal and comprising:
a reservoir for storing an amount of the fluid,
a pump system for pumping the fluid out of the reservoir to the upper port of the connector,
a fluidic coupling means for fluidically coupling the reservoir to the upper port of the connector through the pump system when the movable casing is mounted on the pedestal, and
an electrical coupling means for electrically coupling the movable casing to the pedestal.

2. The device according to claim 1, in which the electronic control unit comprises a switch for controlling the operation of the pump system, the switch being preferably a dual in-line package switch or a rotary encoder.

3. The device according to claim 2, in which the pedestal has an upper surface around the upper port and a lower surface around the lower port, the switch being located on the upper surface of the pedestal such that when the pedestal is connected to the movable casing, the switch is unreachable to a user.

4. The device according to claim 1, in which the electronic control unit comprises a wireless communication module able to receive wireless instruction for the operation of the pump system or to send information on the operation of the pump system.

5. The device according to claim 1, in which the movable casing comprises a power source for supplying power to the pump system.

6. The device according to claim 1, in which the electronic control unit comprises at least a sensor configured to sample a parameter of the movable casing.

7. The device according to claim 4, in which the electronic control unit comprises at least a sensor configured to sample a parameter of the movable casing, and in which at least one sensor is able to send measured parameters via the wireless communication module.

8. The device according to claim 6, in which the sensor is a voltage sensor of a power source, or an electric current sensor of the pump system, or an accelerometer, or a proximity sensor able to detect a presence of an operator, or a touch sensor able to detect the presence of the operator, or a magnetic sensor able to detect the presence of the operator.

9. The device according to claim 6, in which the pedestal comprises at least an alarm able to emit a sound or a flashing light when the sensor measures a value of the parameter outside a pre-determined range.

10. The device according to claim 1, in which the pedestal is made of a transparent material, the pedestal comprising at least one light able to indicate an operation condition of the movable casing, or able to confirm an interaction with an operator.

11. The device according to claim 1, in which the movable casing comprises at least an internal port configured to receive electric power and pass power on to the pump system, and the pedestal comprises at least one pin each corresponding to one internal port respectively and configured to receive electric power from the internal port.

12. The device according to claim 1, in which the pedestal comprises a connector port configured to receive electric power from outside the device, and/or receive data from outside the device, and/or send data of the device away from it.

13. The device according to claim 1, in which the upper port of the connector is threaded, the movable casing comprising a threaded hole configured to cooperate with the threaded upper port of the connector such that the pedestal can be fluidically coupled to the movable casing by screwing the threaded hole of the movable casing onto the threaded upper port of the connector.

14. A method of using a device according to claim 1, comprising the following steps:
fluidically coupling the lower port of the connector to the consumption point, and mechanically coupling the pedestal to the consumption point,
fluidically coupling the reservoir to the upper port of the connector through the pump system by the fluidic coupling means, and
positioning and mounting the movable casing on the pedestal,
the pump system pumping the fluid out of the reservoir to the upper port of the connector, and
the fluid flowing in the connector from the upper port to the consumption point, the electronic control unit controlling the delivery of the fluid to the consumption point.

15. The method of using a device according to claim 14, comprising the following steps:
detaching the movable casing from the upper port of the connector while the pedestal remains attached to the consumption point, and
coupling another movable casing to the upper port of the connector.
